(19) United States
(12) Patent Application Publication
(10) Pub. No.: US 2025/0298161 A1
(43) Pub. Date: Sep. 25, 2025

(54) REGULATED VELOCITY DROP MECHANISM FOR SENSING NODE AND METHOD

(71) Applicant: SERCEL, Carquefou (FR)

(72) Inventor: Christian GREGOIRE, La chapelle sur erdre (FR)

(21) Appl. No.: 18/614,039

(22) Filed: Mar. 22, 2024

(51) Int. Cl. G01V 1/16; B60P 1/36; B60P 1/56; G01B 21/16

(52) U.S. Cl. CPC G01V 1/168; B60P 1/56; G01B 21/16; B60P 1/36; G01V 2210/1425

(57) ABSTRACT

A sensing node distribution system for dropping plural sensing nodes on the ground includes a storage system configured to be carried by a vehicle and to store the plural sensing nodes and a deploying system functionally connected to the storage system and configured to distribute the plural sensing nodes on the ground by dropping. The deploying system is configured to control an ejecting horizontal speed vₙ of each sensing node relative to the storage system so that the horizontal speed vₙ is substantially equal to a storage system horizontal speed vᵥ relative to the ground.

### BACKGROUND

### Technical Field

Embodiments of the subject matter disclosed herein generally relate to systems and methods for mechanically and automatically deploying sensing nodes in the field, and more particularly, to dropping the sensing nodes on the ground with a substantially zero horizontal speed relative to the ground, for preparing an acquisition campaign that uses high channel counts for collecting seismic data.

### Discussion of the Background

Seismic surveying investigates and maps the structure and character of geological formations underground using, for example, reflection seismology. Reflection seismology is a method of geophysical exploration especially helpful in the oil and gas industry, but also deployed for other purposes like geothermal projects, CO₂ underground storage, minerals detection, etc. In reflection seismology, the depth and the horizontal location of features causing reflections of seismic waves are evaluated by measuring the time it takes for the seismic wave to travel from a source to one or more sensing nodes (e.g., seismic sensors) deployed over the region of interest. These features may be associated with subterranean hydrocarbon reservoirs and their image is sharper when a large number of sensing nodes is used. However, this large number of sensing nodes requires intense human involvement as discussed next.

Typically, a land seismic surveying system 100, which is illustrated in FIG. 1, uses numerous seismic sensing nodes 110 for surveying a large area 120 to explore subsurface resources, before drilling wells or performing other invasive and/or costly acts, the sensing nodes being cabled (i.e. linked to each other and to a central unit through a cable) or not. In particular, a system 100 may include hundreds if not thousands of non-cabled seismic nodes 110, and the nodes are distributed and oriented over the entire area 120 of interest for recording seismic signals. In the following, a non-cabled seismic node, also referred to as “an autonomous node” or “wireless node,” is understood to be a node that communicates over the air with another element, e.g., the central unit or another node or a harvester. The term “over the air” includes the traditional radio frequency (RF) communications (e.g., long range broadcasting signals like FM, AM, or short range like WiFi, Bluetooth, etc.) but also sound based communications or optical based communications, practically any means that does not uses a cable or wire. The cableless, or autonomous, seismic nodes 110 can be placed according to a given orderly pattern over the area 120, or in any other way. Traditionally, each seismic node needs to be oriented so that its sensing axis is substantially vertical. This constraint significantly increases the deployment time of the nodes. The autonomous seismic nodes 110 may be configured to exchange (non-seismic) data between them, in an ad-hoc network.

In one implementation, the cableless seismic nodes 110 communicate, e.g., through wireless means, with a general controller 130 and can receive instructions or commands from this controller. In some implementations, a harvester 140, having its own antenna 142 and processing capabilities 144, can move about each node and collect the stored seismic data. Each seismic node 110 includes dedicated electronics (microprocessor, storage device, e.g., a memory, transceiver, seismic sensor, etc.) that is housed inside the node's housing, and may have an antenna 112, for wireless communication with the harvester 140.

The recording of the seismic signals (or other signals) can be implemented in various ways, for example, in short periods of time repeated over a long period of time, or continuously over a long period of time. Regardless of the method selected for recording the seismic data, the traditional seismic nodes 110 need to be carefully placed on the ground, also to achieve a good coupling with the ground for accurate sensing. In addition, some of the traditional seismic nodes need to be placed with a certain orientation relative to the ground, so that their antenna is at the highest point of the node. Deploying the node to achieve the desired pattern is the largest time-consuming operation for a land seismic acquisition campaign.

As the current seismic acquisition campaigns are faced with an increased pressure of reducing the cost of their operations, there is a need for a new method for deploying the nodes so that a reduced deployment and retrieving time for the sensors/nodes is achieved.

### BRIEF SUMMARY OF THE INVENTION

Deploying and retrieving nodes and/or sensors for seismic data acquisition (or other data) may be performed with a node that self-adjusts its sensing axis relative to the vertical so that a tilt angle between the gravity and the sensing axis does not negatively impact the recording of the data. Such a node does not require a certain orientation when deployed in the field. Thus, a vehicle configured with a storage area for such nodes and with a dropping system for automatically deploying the nodes onto the ground would reduce the deployment time. The dropping system needs to be able to control a horizontal speed of the node relative to the vehicle, so that a horizontal speed of the node relative to the ground is substantially zero, to prevent a rolling of the node when landing on the ground. In one application, the dropping system is configured to determine the height of a release position of the node relative to the ground and to adjust this height. This system is also beneficial for nodes with a dedicated shape, e.g., flat shape, which inherently land with a correct orientation when deployed.

According to an embodiment, there is a sensing node distribution system for dropping plural sensing nodes on the ground, and the sensing node distribution system includes a storage system configured to be carried by a vehicle and to store the plural sensing nodes and a deploying system functionally connected to the storage system and configured to distribute the plural sensing nodes on the ground by dropping. The deploying system is configured to control an ejecting horizontal speed vₙ of each sensing node relative to the storage system so that the horizontal speed vₙ is substantially equal to a storage system horizontal speed vᵥ relative to the ground.

According to another embodiment, there is a deploying system to be attached to a vehicle, and the deploying system includes a slide making a non-zero angle with a horizontal direction, and configured to eject a sensing node stored by the vehicle, with a substantially zero horizontal speed relative to the ground, a horizontal rail configured to hold a first platform, and a vertical rail configured to hold a second platform. A first end of the slide is attached to the first platform and a second end of the slide is attached to the second platform.

According to yet another embodiment, there is a method for automatically deploying plural sensing nodes on the ground, and the method includes traversing with a vehicle a given field, adjusting at least one of: a height H of an end of a slide of a deploying system, an angle between the slide and a horizontal direction, and an initial acceleration of a sensing node so that an ejecting horizontal speed vₙ of the sensing node, relative to the vehicle, is equal and opposite to a horizontal speed vᵥ of the vehicle, transferring the sensing node from a storage of the vehicle to the deploying system, and ejecting the sensing node with the horizontal speed vₙ so that a speed of the sensing node relative to the ground is substantially zero.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a conventional land seismic surveying system;

FIG. 2 is a schematic diagram of a sensing node distribution system that automatically distributes sensing nodes on the ground;

FIG. 3 is a schematic diagram of the sensing node distribution system of FIG. 2 having a deploying system that includes a slide;

FIG. 4 is a schematic diagram of the sensing node distribution system having an acceleration unit;

FIG. 5 is a schematic diagram of the deploying system;

FIGS. 6A to 6D are schematic diagrams of various acceleration units used with the deploying system;

FIG. 7 is a schematic diagram of another deploying system;

FIG. 8A is a schematic diagram of the sensing node distribution system having a mechanized storage system and a conveyor based deploying system and FIG. 8B shows a similar system in which the storage system is not mechanized, but uses only the gravity for delivering the nodes to the conveyor based deploying system;

FIGS. 9A and 9B schematically illustrate the deploying system relying on one or two conveyors;

FIG. 10 is a schematic diagram of the sensing node distribution system having an arm-based deploying system;

FIG. 11 is a schematic diagram of the sensing node distribution system having one or more height detecting sensors for avoiding an obstacle; and

FIG. 12 is a flow chart of a method for automatically distributing seismic nodes by dropping them on the ground.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a deployment vehicle having a node dropping system that is capable, without human intervention, of dropping the nodes on the ground, one by one, along a driving direction. However, the embodiments to be discussed next are not limited to a dropping system that can deploy one node at a time, but may be applied to larger deployment vehicles that can simultaneously deploy two or more nodes. While the following embodiments are discussed, for practicality, with regard to a seismic sensing node, the teachings in these embodiments equally apply to any sensing node, not only seismic sensing.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

It is noted that by providing a deployment vehicle equipped with a dropping system for automatically deploying sensing nodes on the ground, without human intervention (or minimum intervention), reduces the time for performing the seismic survey, reduces the number of people needed for node deployment, and also reduces the possibility of accidents, thus being conducive to improved health, safety, and environment (HSE) conditions.

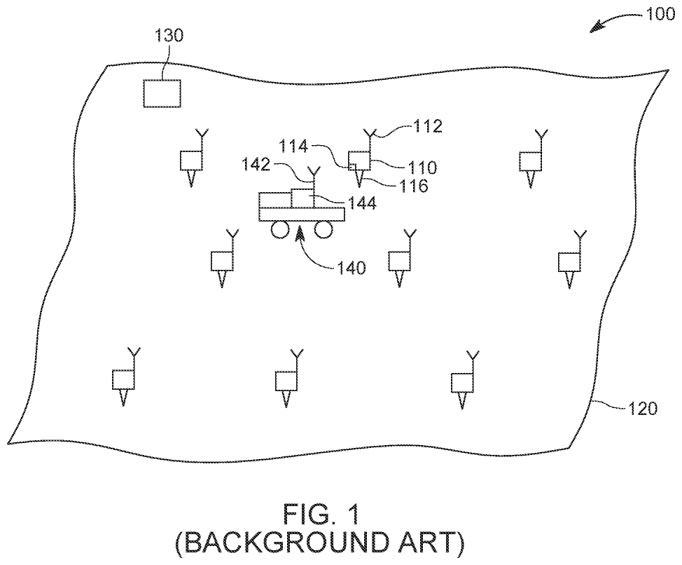

Before discussing the embodiments of the invention, it is noted that [1] discloses a seismic sensor deployment vehicle 100 that uses a node plant mechanism 107 (see FIG. 1 in [1]) for pressing a node into the ground for achieving a good coupling. However, because the node needs to partially enter the ground, as shown in the figure, the vehicle 100 has to stop for a period of time, to allow the node plant mechanism 107 to press the node into the ground. Thus, the need to orient the node and also the need to make sure that the node is partially embedded into the ground, makes this approach slow. The embodiments discussed herein overcome these problems as now discussed.

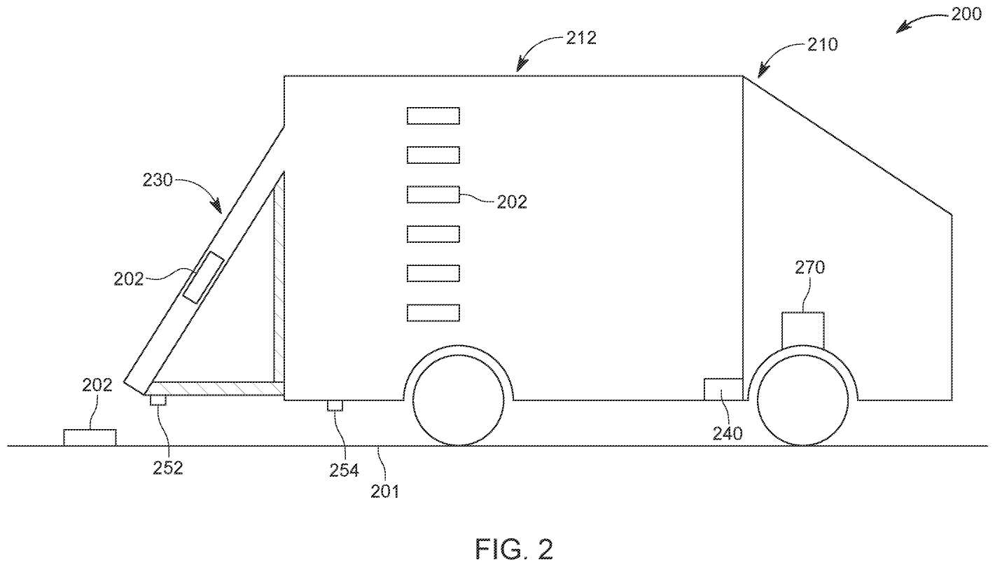

According to an embodiment, a deployment system 200, which is schematically illustrated in FIG. 2, is configured to automatically deploy sensing nodes onto the ground with a substantially zero horizontal speed, so that the sensing nodes do not roll over the ground when released. The term “substantially” refers herein to a variation of about 0.2 m/s, negative or positive, relative to the zero speed. In addition, the deployment system is configured to continuously move while the sensing nodes are deployed, i.e., the deployment system does not need to stop for each node, as the nodes are not partially placed into the ground. The nodes may be special nodes, disclosed in sister patent application Ser. No. 18/442,556, filed on Feb. 21, 2024, and having the title “Self-orienting sensing node and method”, assigned to the assignee of this application and in copending U.S. patent application filed on the same day as this application, and having the docket no. 0337-136 and having the title “Self-orienting spherical sensing node and method,” both of which are included herein by reference in their entirety. Because the node described in the sister patent application does not need to be planted into the ground, the deployment system can drop the nodes, stored on the vehicle in a storage area, while in motion. The same can be applicable for nodes without self-adjustment, which are designed for being placed on the ground with a preferred orientation, should the soil be relatively flat, as e.g., flat-shaped cylinders or parallelepipeds.

More specifically, FIG. 2 shows the deployment system 200 including a deployment vehicle 210 having a storage system 212 that stores plural nodes 202. The vehicle 210 may be any type of vehicle, for example, truck, tractor trailer, airborne vehicle, etc. A deploying system 230 is attached to the back of the vehicle 210 for receiving the nodes 202 from the storage system 212 and distributing them on the ground 201 without human intervention, and with no need to stop the vehicle. A processing device 240, which is located on the vehicle, coordinates the movement of the vehicle 210 (for example, its speed), the storage system 212 (for example, to supply nodes to the deploying system 230), and the deploying system 230 (for example, to control a release speed of the node relative to the ground) so that each node 202 is landing on the ground with a horizontal speed as close as possible to zero, to prevent node rolling.

The system 200 may further include location sensors 252 and 254 for determining a release height of the nodes from the deploying system 230 and/or for adjusting a height of the deploying system when an obstacle is encountered. One location sensor 252 may be attached to the deploying system 230 and the other location sensor 254 may be attached to the vehicle 210. The processing device 240 is connected to these sensors and calculates a height of the lower part of the deploying system 230 as discussed later.

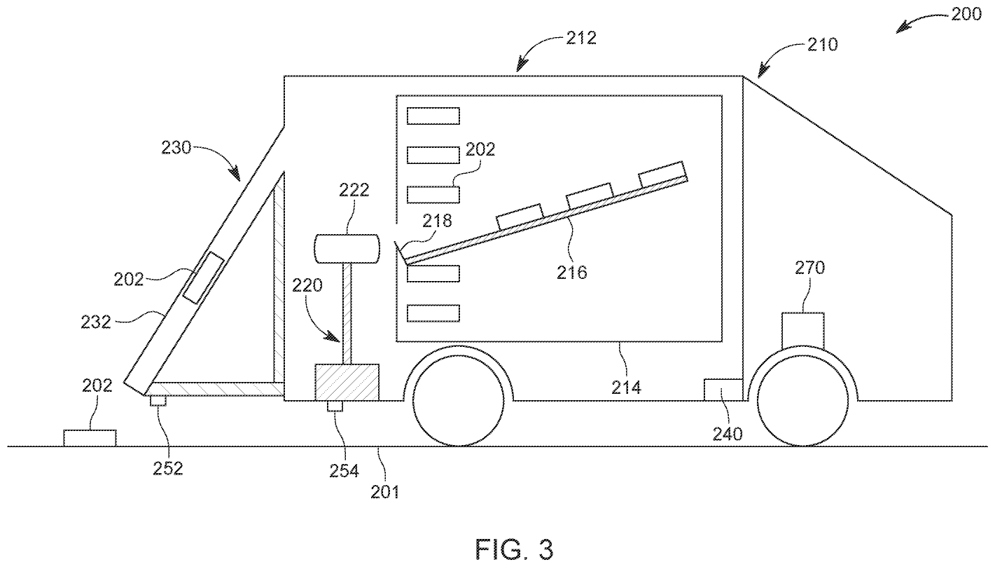

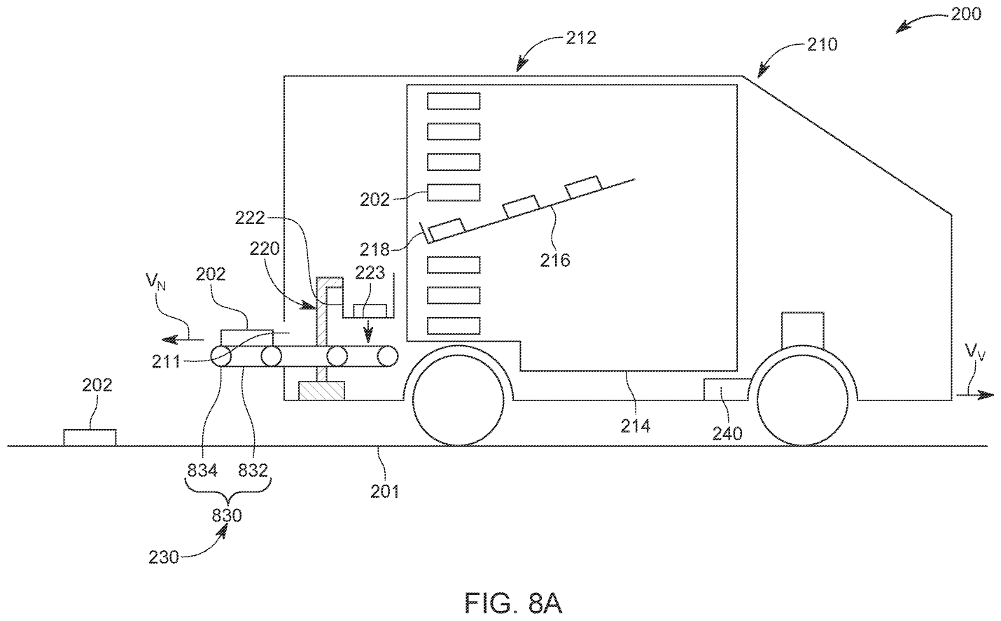

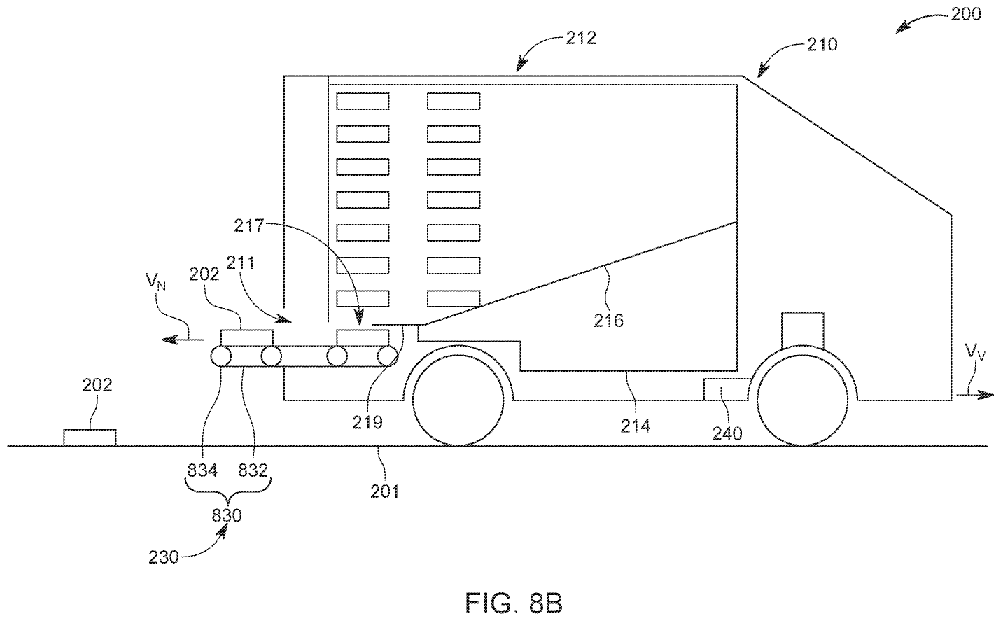

The storage system 212 may be implemented in various ways, for example, as a mechanized storage system that includes a motor or similar devices for automatically dispending the nodes to the deploying system 230, or a non-mechanized storage system, which uses the gravity for dispensing the nodes. In the following, a mechanized storage system is discussed for simplicity. However, a non-mechanized storage system is later discussed with regard to FIG. 8B. In one embodiment, as illustrated in FIG. 3, the mechanized storage system 212 may include a cage 214 for storing plural sensing nodes 202, and a distribution system 220 for moving each node from the cage 214 to the deploying system 230. The deploying system 230 includes a slide 232 (which may have or not a closed top) with an adjustable angle and/or height, for deploying each node 202 to the ground.

The cage 214 may include plural inclined shelfs 216 (only one is shown for simplicity), each shelf having a movable gate 218 for allowing one node from the shelf to enter the distribution system 220. The shelf may make a non-zero angle with the horizontal so that, when gate 218 is opened, the nodes slide along the shelf, toward the distribution system 220. The distribution system 220 may include a movable holder 222, which receives the node 202 and delivers it to the slide 232 of the deploying system 230. The implementation shown in FIG. 3 for the mechanized storage system 212 is one of many possible implementations. Those skilled in the art would understand that any mechanism that takes a node from the cage and places that node at an input of the deploying system 230 may be used. For example, in a different embodiment, the mechanized storage system may include a movable arm that picks a node and places it at the input of the deploying system 230. The movement of the various components discussed herein, for example, the gate 218, or holder 222 may be coordinated by the processing device 240.

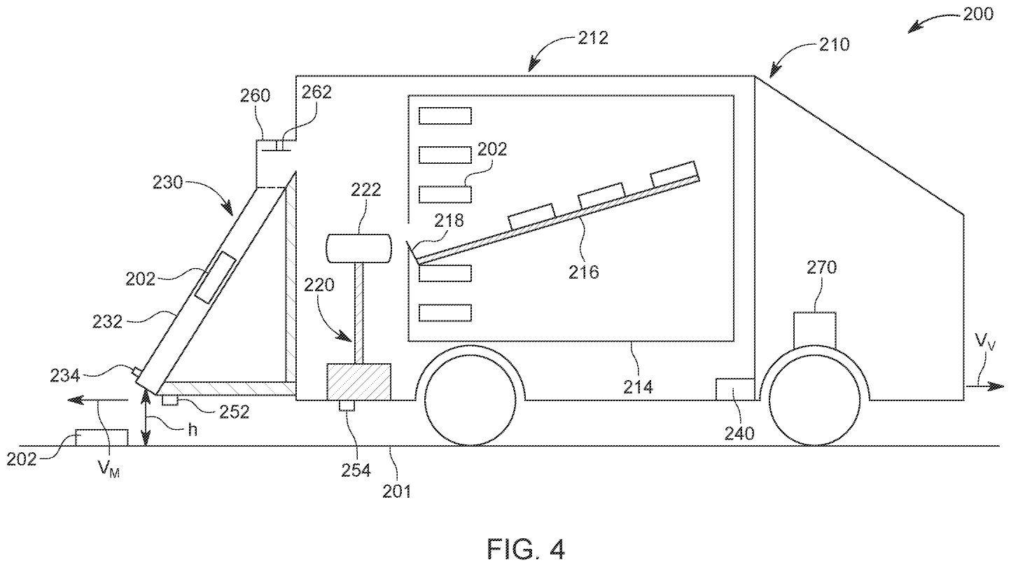

While FIG. 3 shows the holder 222 being configured to place the node 202 from the cage 214 directly into the slide 232, according to another embodiment, as illustrated in FIG. 4, it is possible to have an acceleration unit 260 placed at the top of the slide 232, to provide an initial acceleration aᵢₙᵢₜ to the node 202. In other words, in this embodiment, the mechanized storage system 212 supplies the nodes 202 to the acceleration unit 260, which provides an initial acceleration to the node before entering the slide 232. In this way, the final horizontal speed vₙ of the node relative to the vehicle 212 can be controlled, as discussed later. FIG. 4 also shows the horizontal speed vᵥ of the vehicle, relative to the ground. Note that the mechanized storage system 212 has the same horizontal speed vᵥ as the vehicle. This means that the horizontal speed of the vehicle is used herein interchangeable with the mechanized storage system horizontal speed. Note that the final horizontal speed of the node relative to the ground is desired to be substantially zero and this happens when vₙ is equal in absolute value with vᵥ, but they have opposite directions. Node position uncertainty, after the dropping operation, is estimated taking into account the velocity of the node relative to the ground, the height of the node from the ground, but also the node's shape, its weight, the nature of the ground and the ground slope.

Thus, the deploying system 230 is configured to change one or more of its parameters (e.g., the inclination of the slide, or a height of the lowest point of the slide, or a height of the highest point of the slide, or a combination of any of these factors) with the vehicle speed vᵥ, and/or with the release height h of the node from the ground for achieving the substantially zero velocity speed of the node relative to the ground. While FIGS. 2-4 show the deploying system 230 using the gravitational force, with a drop slide having an ejection slope, it is also possible, as discussed later, to use a conveying mechanism to launch each individual node at a given speed relative to the vehicle.

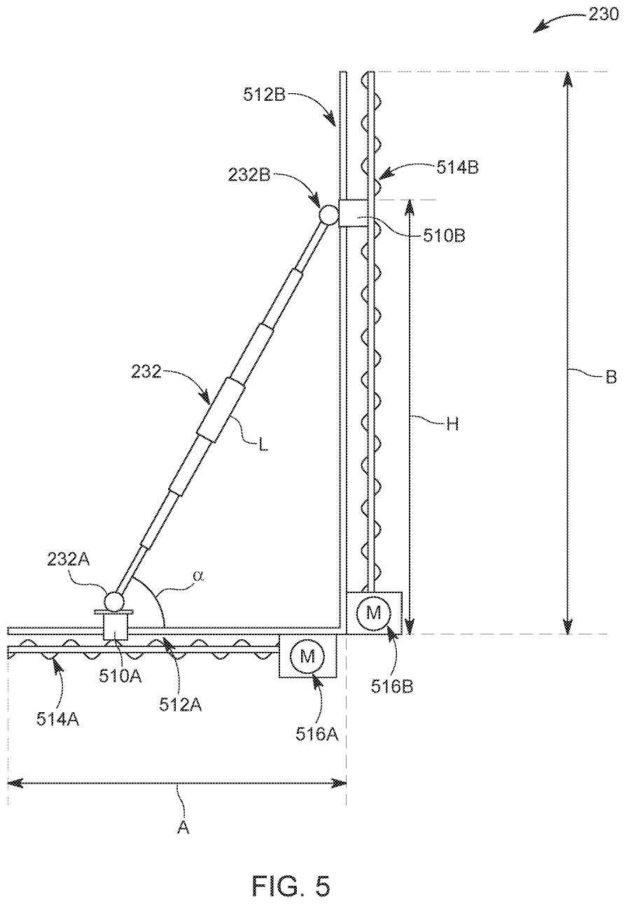

In one embodiment, the deploying system 230 illustrated in FIGS. 2 to 4 may be implemented as illustrated in FIG. 5. The deploying system 230 is configured to change a vertical height H and an angle α of the slide 232 (note that the slide may include plural elements and thus a length L of the slide may be adjusted). In one application, the initial node's acceleration aᵢₙᵢₜ can also be adjusted so that node's horizontal velocity vₙ at the lowest end 232A of the slide 232 is substantially the opposite of the vehicle's horizontal velocity vᵥ, which implies a velocity of the node relative to the ground close to zero.

To change the height H and/or the angle α of the slide, in this embodiment, the lowest end 232A of the slide 232 is attached to a mobile platform 510A, which is configured to move back and forth along a horizontal rail 512A. A horizontal endless screw 514A, which is activated by a first stepping motor 516A, rotates the screw 514A, so that the platform 510A moves back and forth along the rail 512A. In this way, the length L and the angle α of the slide 232 can be adjusted. A similar mechanism (510B, 512B, 514B, and 516B) may be provided for the highest end 232B of the slide 232, to move it along the vertical rail 512B. The processing device 240 is configured to actuate the two motors 516A and 516B, Independently, to achieve any desired length L, height H, and angle α combination.

A velocity sensor 234, which is shown in FIG. 4 being located at the lowest end 232A of the slide 232, is configured to measure the node's velocity at the slide's output, and the processing device 240 is configured to compare the measured velocity vₘ relative to the vehicle's speed vᵥ, and regulate the above noted parameters to reduce the potential difference between the two speeds. Depending on the design of the deploying system 230, the aᵢₙᵢₜ, L, and a are calculated depending on the slide form/design.

In one embodiment, in addition to regulating the node's velocity at the output of the slide 232, the computing device 240 is also configured to minimize the height h of the lowest end 232A of the slide 232 relative to the ground, which can be measured by height detector 252, so that displacement of the node after drop is as low as possible.

In one embodiment, the lowest end 232A of slide 232 can be moved up and down, i.e., its height h relative to the ground can be adjusted so that an obstacle present on the ground, e.g., a stone, can be avoided. Alternatively, or in addition, this option is associated with a feedback to the driver and/or driving system 270 (see FIG. 2) of the vehicle 210 to increase/reduce vehicle's speed for increasing an accuracy of the node's landing position after the drop.

The driving system 270 may include any part of the vehicle (e.g., engine) that is associated with rotating the wheels of the vehicle. In one embodiment, the vehicle 210 is autonomous, i.e., does not have a driver, and the driving system 270 fully drives the vehicle. The processing device 240 controls the driving system 270 and makes sure that the speed of the vehicle is adjusted so that the horizontal speed of the node relative to the ground is substantially zero when the node drops onto the ground.

In one embodiment, the factors used for controlling the node's ejection speed are the height H of the slide, the angle α, the friction coefficient μₖ between the node and slide, and the initial acceleration aᵢₙᵢₜ. An accuracy of the final position of the node on the ground, after being dropped, depends on the height h of the ejection port or end 232A and the ejection speed inaccuracy (difference between node ejection speed and vehicle speed on the horizontal direction).

The speed of the vehicle is desired to be maintained between 1 and 5 m/s during the deployment of the nodes. According to a first scenario, for a given friction coefficient μₖ=1.5 between the node and the slide, and having a null initial acceleration aᵢₙᵢₜ, the node's feedback speed v_{f} can be 1 m/s for a height H of 0.4 m with an angle α=60°, and can be 5 m/s for a height H of 1.5 m with an angle α=85°.

For a same given μₖ=1.5, but with an initial acceleration of 2 m/s², it is possible to have a v_{f} value of 1 m/s for a height of 0.14 m with an angle α=60°, and a value of 5 m/s for a height of 1.18 m with an angle α=85°. The length L of the slides varies between 0.46 and 1.51 m for these two cases. To achieve this variable speed, the slide may be made of interlocking mechanical parts. These two examples provide some numerical ranges for the embodiments shown in FIGS. 3 to 5 based on the angle α regulation with constant aᵢₙᵢₜ initial acceleration, for the v_{f} regulation on the vehicle speed. Based on these values, the sizes A and B of the deploying system 230, as illustrated in FIG. 5, vary between 0.23 and 0.13 m, and 0.46 and 1.51 m, respectively.

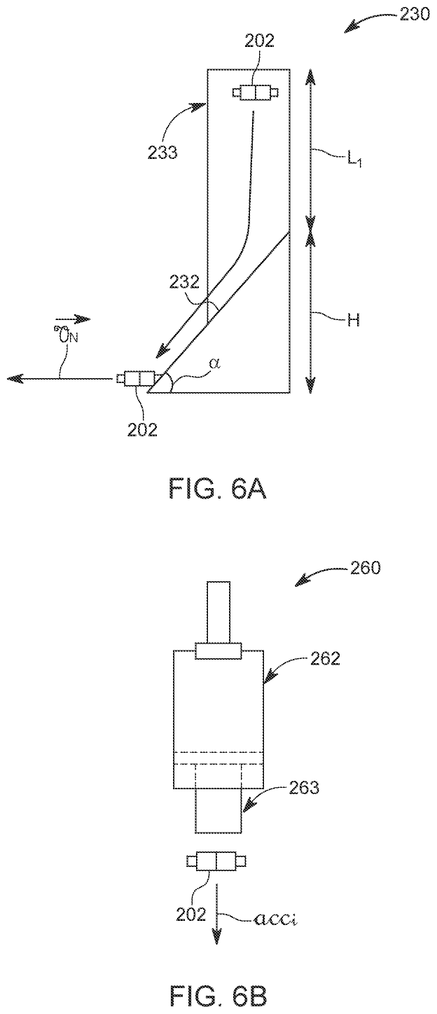

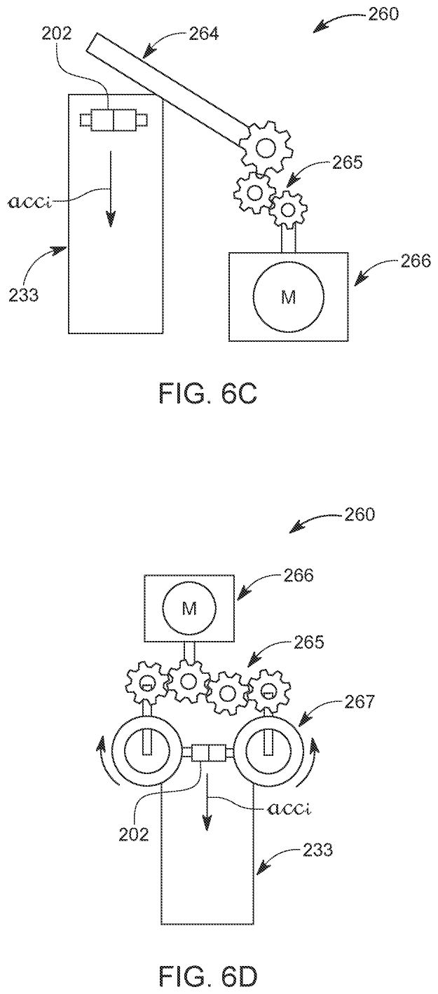

For small angles α, it might be necessary to provide an initial acceleration to the node due to the friction between the node and the slide. Adjusting the acceleration aᵢₙᵢₜ requires the acceleration unit 260 to offer a certain range of possible accelerations and a certain resolution. The acceleration unit 260 can be implemented in various ways, as now discussed with regard to FIGS. 6A to 6D. In a first implementation, as shown in FIG. 6A, the slide 232 has a vertical extension 233, having a certain height L1, in addition to the original height H of the inclined part of the slide. The vertical part of the slide, which might be shaped as a pipe in this embodiment, enables the node to reach a predetermined speed when entering the inclined part of the slide, i.e., to start the incline movement with a non-zero initial acceleration aᵢₙᵢₜ.

In a second embodiment, which is illustrated in FIG. 6B, the acceleration unit 260 is implemented as an air pressure controller having a piston 262 and an ejector 263. Compressed air is supplied to the acceleration unit 260 for creating a force that is transferred to the node for providing the desired initial acceleration. In a third embodiment, which is illustrated in FIG. 6C, the acceleration unit 260 is implemented as a mechanical thrower, having a throwing arm 264, gears 265, and a motor 266 that makes the arm 264 to push the node with the desired initial acceleration. In a fourth embodiment, as shown in FIG. 6D, the acceleration unit 260 is implemented with a pair of rollers 267, which are activated by a motor 266 and a set of gears 265. The pair of rollers 267 are configured to engage the node and impart it a desired initial acceleration. Those skilled in the art, based on these teachings, would be able to devise alternative acceleration units which follow the same principles.

In one embodiment, it might be of use to find a fixed height H and a fixed angle α which cover the output velocity v_{f} targeted range of 1 to 5 m/s. For example, for a friction coefficient μₖ=1.5 and an angle α=60°, it is possible to find a fixed height H of 0.4 m which responds to these needs. In this case, a velocity of 1 m/s is reached with a null initial acceleration aᵢₙᵢₜ whereas a velocity of 5 m/s is reached with an initial aᵢₙᵢₜ=25.9 m/s². In such a case, if different parameters sensitivity are considered, to obtain a dropping velocity accuracy of 0.05 m/s for the node relative to the ground when reaching the ground requires an initial acceleration accuracy of 0+/−0.1 m/s² and 25.9+/−0.6 m/s², an angle α accuracy of 60°+/−0.2°, and a friction coefficient tolerance of μₖ=1.5+/−0.025.

Although the initial acceleration and angle accuracy requirements are reachable, the friction coefficient tolerance seems difficult to achieve as the friction forces coefficient may vary with wear and temperature. Thus, the processing device 240 is configured to control the length L of the slide, the angle α, and the initial acceleration aᵢₙᵢₜ for matching the output feedback velocity v_{f}′ accuracy.

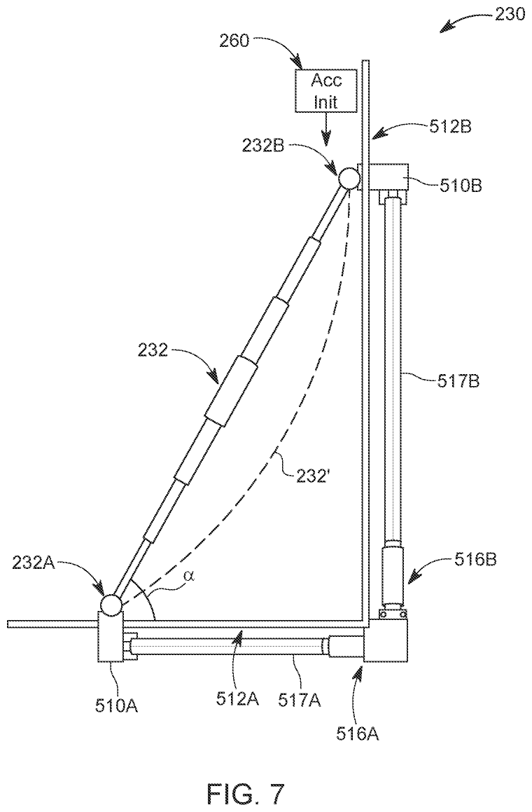

In one variation of the deploying system 230 illustrated in FIG. 7, it is possible to replace the slide 232 of FIG. 5, which is made of a solid material, with a stretchable slide 232, so that when one end moves away relative to the other end, the length of the slide increases while its diameter slightly decreases due to the stretching action. For example, the slide may be made in this embodiment of an elastic rubber. Note that because the slide is elastic, it may have a bent shape, as illustrated in FIG. 7 by the dash line 232′. Such a shape may be permanently achieved by manufacturing the slide to be curved, or by connecting one point of the slide (not shown) to one of the rails or another fixed point of the system and reducing a distance between the slide and the fixed point. Also, the endless screws 514A and 514B may be replaced in this embodiment with telescopic arms 517A and 517B, respectively.

In a different implementation, as illustrated in FIG. 8A, the deploying system 230 uses one or more conveyors 830 for ejecting the node from the vehicle 210. A conveyor belt 832 of the conveyor 830 is rotated by one or more wheels 834, which are controlled by the processing device 240. Thus, a speed of the conveyor belt is selected by the processing device 240 to match a speed of the vehicle 210. The conveyor belt extends partially outside and partially inside the vehicle, so that it can receive a node 202 from the cage 214. The distribution system 220 includes a holder 222 that is positioned, in this embodiment, next to the gate 218, for receiving one node 202 at a time. Other mechanisms may be used for moving the nodes from the cage to the conveyor belt. The holder 222 may have a movable bottom 223, which can swing open to release the node 202 onto the conveyor belt 832. The node 202 then travels through an opening 211 into the housing of the vehicle 210 and it is ejected from the vehicle with a horizontal speed vₙ relative to the vehicle, which is equal to the horizontal speed vᵥ of the vehicle relative to the ground. In this way, the horizontal speed of the node relative to the ground is substantially zero at the landing point.

While the embodiment of FIG. 8A shows a mechanized storage system 212, it is also possible to have the storage system use only the gravity for delivering the nodes 202 to the deploying system 230, as illustrated in FIG. 8B. This non-mechanized storage system 212 may have all the nodes 202 located on inclined shelves 216, thus feeding by gravity the nodes 202 to an opening 217 in the storage system 212. This is especially possible as the nodes 202 can roll as they are either longitudinally symmetrical (in terms of the exterior shape) or spherical (in terms of the exterior shape). The opening 217 is located above the conveyor belt 832 so that the nodes fall directly onto the conveyor belt. In one implementation, a movable door 219 may partially block the opening 217 for ensuring that one node at a time is released onto the conveyor belt 832. For this embodiment, the deploying system 230 may be configured to activate door 219. Thus, the storage system in this embodiment does not require any motor or actuation device or the intervention of an operator, except for originally feeding the nodes 202 to cage 214 of the storage system 212. Note that this non-mechanized storage system variant may also be used with a non-mechanized deploying system 230, for example, using only the slide 232.

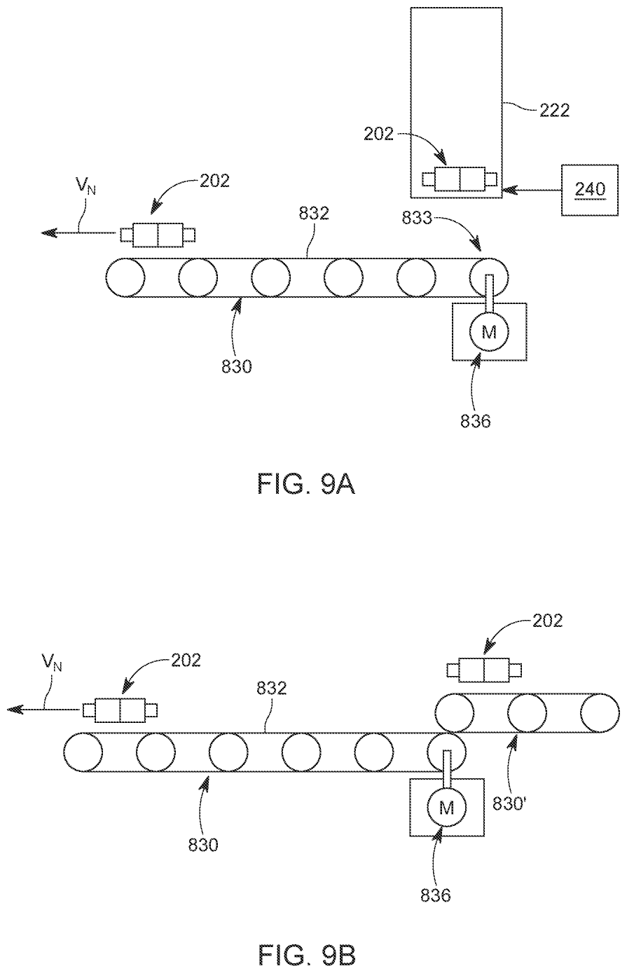

The deploying system 230 may be implemented with a single conveyor 830 as shown in FIG. 9A or with two conveyors 830 and 830′ as shown in FIG. 9B. FIG. 9A shows that motor 836 controls the speed of the conveyor belt 832. FIG. 9B shows a second conveyor 830′ that feeds the nodes 202 to the first conveyor 830. Thus, for this embodiment, node 202 is placed at entry point 833 of the conveyor belt 832. The conveyor belt 832 is moving at a velocity controlled by the stepping motor 836. The node entry 833 of conveyor belt 832 may be the movable holder 222, or a pipe, which can drop the node due to a drop command, as illustrated in FIG. 9A, or may be another conveyor 830′, as illustrated in FIG. 9B.

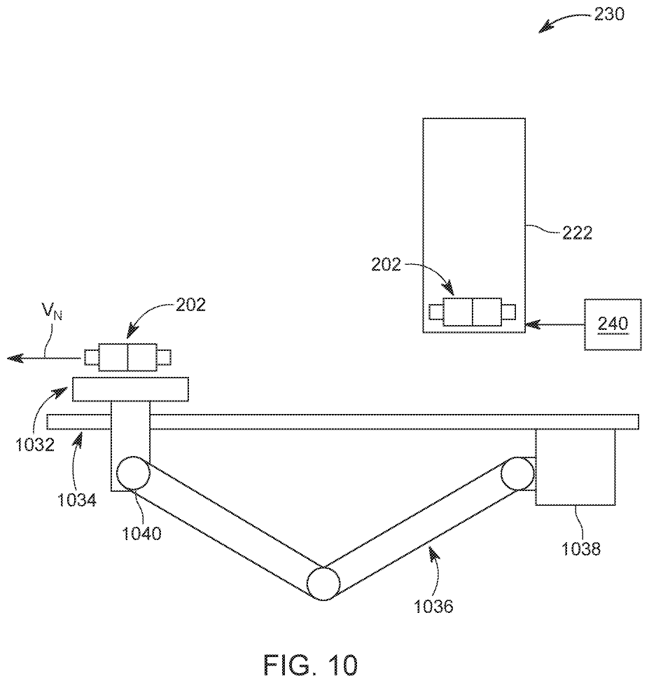

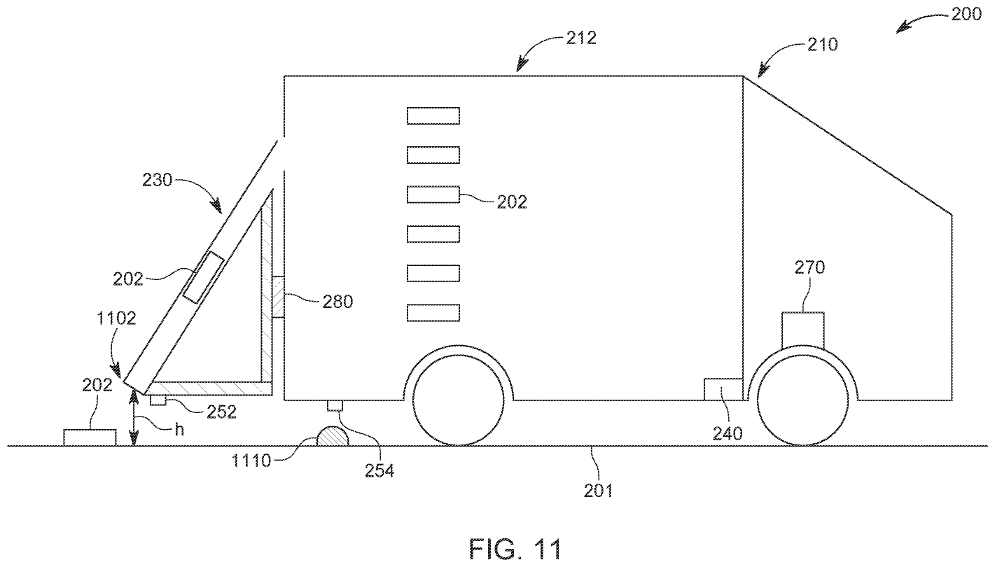

An alternative to the embodiments illustrated in FIGS. 9A and 9B is the use of a movable arm, as shown in FIG. 10, for ejecting the node 202 from the vehicle 210. More specifically, FIG. 10 shows the deploying system 230 being implemented as a node carrier 1032 that moves along a horizontal rail 1034 due to a mechanical arm 1036. The mechanical arm 1036 is actuated by a motor 1038. The mechanical arm 1036 is positioned in a horizontal plane to not extend toward the ground. The node carrier 1032 moves, due to the mechanical arm 1036, under the holder 222, to receive the node 202. Note that processing device 240 controls a bottom wall of the holder 222, to release the node when the node carrier is under it. Then, the processing device 240 activates the motor 1038 to move the node carrier 1032 along the rail 1034, so that a final velocity of the node carrier 1032 is equal to or larger than the horizontal speed vᵥ of the vehicle. When the node carrier 1032 reaches a launching point or position 1040, the node carrier suddenly stops. Due to inertia, the node 202 is ejected substantially with the horizontal speed vᵥ of the vehicle, but with an opposite direction. In this way, the actual horizontal speed of the node relative to the ground is substantially zero, and thus the node lands on the ground with no or minimal rolling. After this, the mechanical arm 1036 is retracted to prepare the node carrier to receive the next node. The process automatically and autonomously continues until the desired number of nodes is distributed over the ground.

No matter how the deploying system 230 is implemented, in one embodiment, as illustrated in FIG. 11, a height adjusting mechanism 280 may be provided between the vehicle 210 and the deploying system 230 so that the entire deploying system may be moved up or down, to adjust the height h of the ejection point 1102. The processing device 240 uses the two height sensors 252 and 254 to detect a possible obstacle, for example, a larger rock, and to adjust accordingly the height h, either to increase or decrease it. For example, in case of an obstacle 1110, the vehicle's height detector 254 measures the obstacle's height and sends a measurement to the processing device 240. The processing device calculates the necessary clearing distance between the top of the obstacle and the ejection point, and instructs the height adjusting mechanism 280 to adjust (increase in this case) the height h of the point 1102 to avoid collision with the obstacle. The measurement, the sending of the command, and the height adjustment need to be realized fast enough to avoid collision. Thus, height detector 254 placed under the vehicle may be placed in the front of the vehicle rather than the back so that the processing device 240 has more time to proceed.

As previously mentioned, one or more or all the operations described herein with regard to the figures may be automatically performed by the processing device 240, without input from the operator. In one application, when the processing device 240 is integrated with the driving system 270 of the vehicle, the processing device controls the speed vᵥ of the vehicle, the distribution system 220, and the deploying system 230 so that all the nodes 202 are dropped on the ground, at desired locations, with no human intervention.

While the embodiments discussed above disclose one deploying system 230 per vehicle, those skilled in the art would understand that it is possible to have plural deploying systems attached to the vehicle, so that plural nodes can be dropped at a given time. For this situation, the addition deploying systems 230 may be located on the sides of the vehicle.

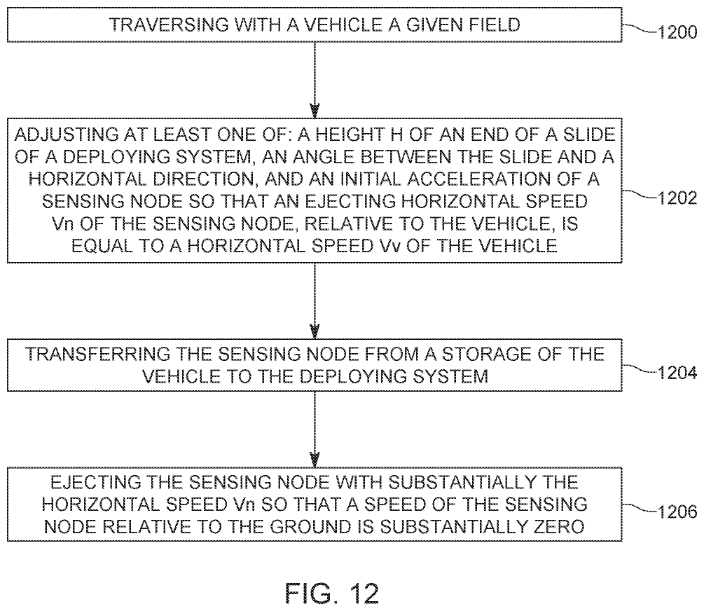

A method for automatically deploying plural sensing nodes on the ground is now discussed with regard to FIG. 12. The method includes a step 1200 of traversing with a vehicle 210 a given field, a step 1202 of adjusting at least one of: a height H of an end 232B of a slide 232 of a deploying system 230, an angle between the slide 232 and a horizontal direction, and an initial acceleration of a sensing node 202 so that an ejecting horizontal speed vₙ of the sensing node, relative to the vehicle, is equal to a horizontal speed vᵥ of the vehicle. The method further includes a step 1204 of transferring the sensing node from a storage of the vehicle to the deploying system, and a step 1206 of ejecting the sensing node with substantially the horizontal speed vₙ so that a speed of the sensing node relative to the ground is substantially zero.

In one embodiment, a self-orienting sensing node 202 (which can be cylindrical in shape and thus, having a longitudinal axis, or spherical in shape and thus, having a center of symmetry) is used so that there is no need to drop the node with a certain orientation relative to the ground. In this embodiment, the self-orienting node 202 includes a double housing, an inner housing and an outer housing, which fully receives and encloses the inner housing. Each of the inner and outer housings has a corresponding longitudinal axis, which are parallel to each other and preferably coincident. The outer housing is configured to seal the inner housing from the ambient. The inner housing is fully independent of the outer housing, i.e., it can freely rotate inside the outer housing, relative to a longitudinal axis of the outer housing. In one application, there are no wires leaving the inner housing, i.e., no wires connecting the inner and outer housings. In one application, a ball bearing mechanism (or similar or equivalent mechanism) is the only mechanical connection between the inner and outer housings. The inner and outer housings may have the same or different shapes and/or profiles as long as the inner housing is free to rotate inside the outer housing. For maximizing use of the inner cavity of the outer housing, in one application, the outer surface of the inner housing is cylindrical, and the inner surface of the outer housing is also cylindrical. In this application, a radial distance between the two surfaces is minimized, for example, equal to or less than 1 mm. Because of the full independence of the inner housing relative to the outer housing, the data acquired by the seismic sensor, which is provided inside the inner housing, may be communicated outside the outer housing through a wireless method. The inner housing may host seismic sensor and associated electronics. The seismic sensor may be a geophone, accelerometer, etc.

In an example embodiment, processing device 240 may be configured to execute instructions stored in the memory device or otherwise accessible to the processor. Alternatively, or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The disclosed embodiments provide a system for (seismic) automatic sensing node distribution in the field with no or minimum roll over. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCE

[1] U.S. Pat. No. 10,222,496;

What is claimed is:

1. A sensing node distribution system for dropping plural sensing nodes on the ground, the sensing node distribution system comprising:
a storage system configured to be carried by a vehicle and to store the plural sensing nodes; and
a deploying system functionally connected to the storage system and configured to distribute the plural sensing nodes on the ground by dropping,
wherein the deploying system is configured to control an ejecting horizontal speed vₙ of each sensing node relative to the storage system so that the horizontal speed vₙ is substantially equal to a storage system horizontal speed vᵥ relative to the ground.

2. The system of claim 1, wherein the storage system comprises:
a cage configured to hold the plural sensing nodes, wherein the cage is part of the storage system; and
a mechanized distribution system which is configured to automatically move a sensing node of the plural sensing nodes, from the cage to the deploying system.

3. The system of claim 1, wherein the deploying system comprises:
a slide making a non-zero angle with a horizontal direction, and configured to eject a sensing node of the plural sensing nodes with a substantially zero horizontal speed relative to the ground.

4. The system of claim 3, wherein the deploying system further comprises:
an acceleration unit configured to impart an initial acceleration to the sensing node, before entering the slide.

5. The system of claim 4, wherein the deploying system further includes:
a horizontal rail configured to hold a first platform; and
a vertical rail configured to hold a second platform,
wherein a first end of the slide is attached to the first platform and a second end of the slide is attached to the second platform.

6. The system of claim 5, wherein each of the first and second platforms moves along respective rails in an independent manner, so that a height H of a highest end of the slide and an angle between the slide and the horizontal rail are adjusted.

7. The system of claim 6, wherein the storage system is mechanized for automatically moving a sensing node from the storage system to the deploying system, and further comprising:
a processing device configured to control at least one of the height H, the angle of the slide, or the initial acceleration of the node so that the resulting ejecting horizontal speed vₙ of the sensing node is adjusted to match the mechanized storage system horizontal speed.

8. The system of claim 3, wherein the slide is stretchable.

9. The system of claim 1, wherein the deploying system comprises:
a first conveyor configured to receive a sensing node of the plural sensing nodes, and to eject the sensing node with a substantially zero horizontal speed relative to the ground.

10. The system of claim 9, further comprising:
a second conveyor configured to feed the first conveyor.

11. The system of claim 1, wherein the deploying system comprises:
a horizontal rail;
a node carrier configured to receive a sensing node and move the sensing node along the horizontal rail; and
a mechanical arm attached to the node carrier and configured to impart the ejecting horizontal speed vₙ to the node carrier.

12. The system of claim 1, further comprising:
a height adjusting mechanism configured to attach the deploying system to the vehicle,
wherein the height adjusting mechanism is configured to adjust a height of the deploying system relative to the ground.

13. The system of claim 1, further comprising:
a processing device; and
a height sensor attached to the vehicle and configured to measure a height of an obstacle,
wherein the processing device is configured to raise the deploying system based on the measured height of the obstacle, to prevent a collision between the deploying system and the obstacle.

14. A deploying system to be attached to a vehicle, the deploying system comprising:
a slide making a non-zero angle with a horizontal direction, and configured to eject a sensing node stored by the vehicle, with a substantially zero horizontal speed relative to the ground;
a horizontal rail configured to hold a first platform; and
a vertical rail configured to hold a second platform,
wherein a first end of the slide is attached to the first platform and a second end of the slide is attached to the second platform.

15. The system of claim 14, wherein each of the first and second platforms is configured to move along respective rails in an independent manner, so that a height H of a second end of the slide and an angle between the slide and the horizontal rail are adjustable.

16. The system of claim 15, further comprising:
an acceleration unit configured to impart an initial acceleration to the sensing node, before entering the slide.

17. The system of claim 16, further comprising:
a processing device configured to control at least one of the height H, the angle of the slide, or the initial acceleration of the sensing node so that the resulting ejecting horizontal speed vₙ of the sensing node is adjusted to match the vehicle horizontal speed.

18. The system of claim 14, further comprising:
a height adjusting mechanism configured to attach the deploying system to the vehicle,
wherein the height adjusting mechanism is configured to adjust a height of the deploying system relative to the ground.

19. The system of claim 18, further comprising:
a processing device; and
a height sensor attached to the vehicle and configured to measure a height of an obstacle,
wherein the processing device is configured to raise the deploying system based on the measured height of the obstacle, to prevent a collision between the deploying system and the obstacle.

20. A method for automatically deploying plural sensing nodes on the ground, the method comprising:
traversing with a vehicle a given field;
adjusting at least one of: a height H of an end of a slide of a deploying system, an angle between the slide and a horizontal direction, and an initial acceleration of a sensing node so that an ejecting horizontal speed vₙ of the sensing node, relative to the vehicle, is equal and opposite to a horizontal speed vᵥ of the vehicle;
transferring the sensing node from a storage of the vehicle to the deploying system; and
ejecting the sensing node with the horizontal speed vₙ so that a speed of the sensing node relative to the ground is substantially zero.
